(19) United States
(12) Patent Application Publication
(10) Pub. No.: US 2013/0308617 A1
(43) Pub. Date: Nov. 21, 2013

(54) Continuous Virtual Private Local Area Network (LAN) Service (VPLS) Over Wireline and Wireless Networks

(71) Applicants: Pei Ling Chuah, Petaling Jaya (MY); Yik Shaw Ngoo, Petaling Jaya (MY); Zing Yee Poon, Petaling Jaya (MY)

(72) Inventors: Pei Ling Chuah, Petaling Jaya (MY); Yik Shaw Ngoo, Petaling Jaya (MY); Zing Yee Poon, Petaling Jaya (MY)

(73) Assignee: International Business Machines Corporation, Armonk, NY (US)

(21) Appl. No.: 13/472,954

(22) Filed: May 16, 2012

(51) Int. Cl. H04W 40/00

(52) U.S. Cl. 370/338

(57) ABSTRACT

A mechanism is provided for enabling virtual private local area network (LAN) service (VPLS) service within a base station (NodeB/eNodeB). A wireless signal is received from a mobile device. The wireless signal is converted into one or more internet protocol (IP) packets. A VPLS virtual private network (VPN) multiprotocol label switching (MPLS) label is constructed in a header of each IP packet. An egress router is identified for the IP packets. A MPLS label of the egress router is constructed for MPLS routing. The MPLS label is added on top of the VPLS VPN MPLS label in the header of each IP packet. The one or more IP packets are then forwarded to at least one other router within a MPLS network.

### BACKGROUND

The present application relates generally to an improved data processing apparatus and method and more specifically to mechanisms for providing continuous virtual private local area network (LAN) service (VPLS) over wireline and wireless networks.

VPLS provides Ethernet based multipoint to multipoint communication over Internet Protocol (IP)/Multiprotocol Label Switching (MPLS) networks. VPLS allows geographically dispersed sites to share an Ethernet broadcast domain by connecting sites through pseudo-wires. VPLS is a virtual private network (VPN) technology. In contrast to Layer 2 Tunneling Protocol Version 3 (L2TPv3), which allows only point-to-point layer 2 tunnels, VPLS allows any-to-any (multipoint) connectivity. In a VPLS, the LAN at each site is extended to the edge of the provider network. The provider network then emulates a switch or bridge to connect all of the customer LANs to create a single bridged LAN. VPLS is designed for applications that require multipoint or broadcast access.

Since VPLS emulates a LAN, full mesh connectivity is required. There are two methods for full mesh establishment for VPLS: using Border Gateway Protocol (BGP) and Label Distribution Protocol (LDP). A “control plane” is the means by which provider edge (PE) routers communicate for auto-discovery and signaling. Auto-discovery refers to the process of finding other PE routers participating in the same VPN or VPLS. Signaling is the process of establishing pseudo-wires (PW). The PWs constitute the “data plane”, whereby PEs send customer VPN/VPLS traffic to other PEs.

With BGP, auto-discovery as well as signaling are provided. The mechanisms used are very similar to those used in establishing Layer-3 MPLS VPNs. Each PE is configured to participate in a given VPLS. The PE, through the use of BGP, simultaneously discovers all other PEs in the same VPLS, and establishes a full mesh of PWs to those PEs.

With LDP, each PE router must be configured to participate in a given VPLS, and, in addition, be given the addresses of other PEs participating in the same VPLS. A full mesh of LDP sessions is then established between these PEs. LDP is then used to create an equivalent mesh of PWs between those PEs.

An advantage to using PWs as the underlying technology for the data plane is that in case of failure, traffic will automatically be routed along available backup paths in the service provider's network. Failover will be much faster than could be achieved with, for example, Spanning Tree Protocol (STP). VPLS is thus a more reliable solution for linking together Ethernet networks in different locations than simply connecting a Wide Area Network (WAN) link to Ethernet switches in both locations.

### SUMMARY

In one illustrative embodiment, a method, in a data processing system, is provided for enabling virtual private local area network (LAN) service (VPLS) service within a base station (NodeB/eNodeB). The illustrative embodiment receives a wireless signal from a mobile device. The illustrative embodiment converts the wireless signal into one or more internet protocol (IP) packets. The illustrative embodiment constructs a VPLS virtual private network (VPN) multiprotocol label switching (MPLS) label in a header of each IP packet. The illustrative embodiment identifies an egress router for the IP packets. The illustrative embodiment constructs a MPLS label of the egress router for MPLS routing. The illustrative embodiment adds the MPLS label on top of the VPLS VPN MPLS label in the header of each IP packet. The illustrative embodiment then forwards the one or more IP packets to at least one other router within a MPLS network.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary diagram of a system of communication networks and communication devices in which exemplary aspects of the illustrative embodiments may be implemented;

FIG. 2 is a block diagram of an example data processing system in which aspects of the illustrative embodiments may be implemented;

FIG. 3 depicts a block diagram schematically showing the components for providing virtual private local area network (LAN) service (VPLS) across wireline and wireless networks in accordance with an illustrative embodiment;

FIG. 4 depicts a block diagram of a router illustrating an inner structure of the router in accordance with an illustrative embodiment;

FIG. 5 depicts a flowchart outlining exemplary operations performed within an ingress base station (NodeB/eNodeB) to enable VPLS service in accordance with an illustrative embodiment; and

FIG. 6 depicts a flowchart outlining exemplary operations performed within backhaul routers and routers within egress base stations (NodeB/eNodeB) to enable VPLS service in accordance with an illustrative embodiment.

### DETAILED DESCRIPTION

Virtual private local area network (LAN) service (VPLS) provides Ethernet based multipoint to multipoint communication over Internet Protocol (IP)/Multiprotocol Label Switching (MPLS) networks, hence virtual private network (VPN) connectivity to users of VPLS in a wireline network. VPLS allows users to connect many different Ethernet-based local area networks (LANs) together over long distances. VPLS has also been used to provide micro mobility solution in the wireless world. However, currently there is no way to integrate the wireless VPLS service with the wireline VPLS service.

The illustrative embodiments provide a mechanism that integrates both wireline and wireless networks by extending the service of VPLS to wireless customers. Ultimately, the VPN service provides coverage up to the wireless base stations (NodeB/eNodeB), incorporating the router functions at these nodes. As a result, a wireless network is treated as network path corresponding to optical network in wireline network. Relating to the current extended role of VPLS in the presence of wireless networks, VPLS works to realize the network-based micro mobility in such cellular networks. Micro mobility is defined as mobility that is anchored at a fixed IP gateway device; hence, the mobile device is in the micro mobility domain as long as the mobile device's IP gateway does not change as the mobile device moves location. The illustrative embodiments utilize the anchor device (router functions) residing in the wireless base stations (NodeB/eNodeB) or the wireless network to serve a service-oriented IP-enabled router that stores policies and other information, working as a network transmission path.

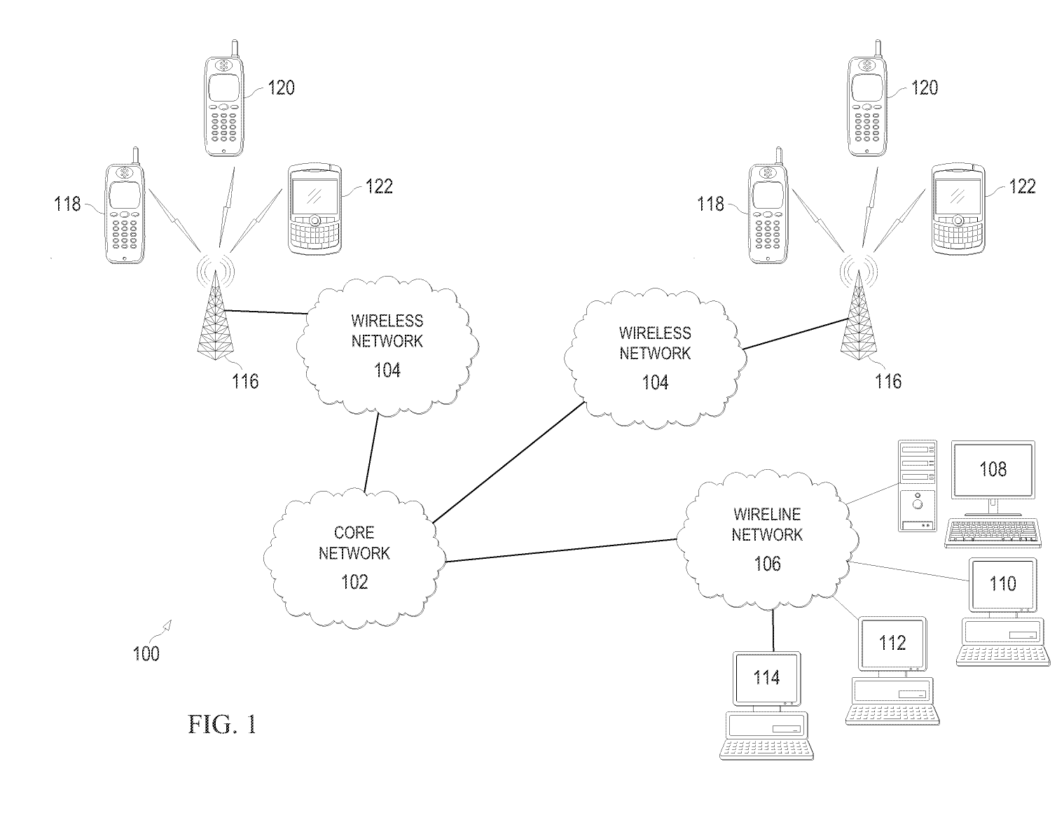

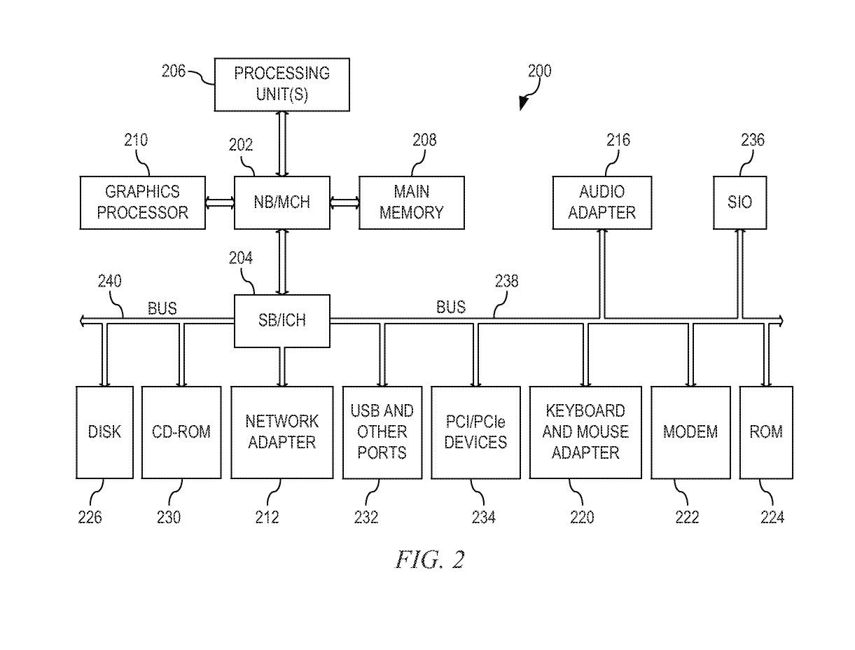

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is an exemplary diagram of a system of communication networks and communication devices in which exemplary aspects of the illustrative embodiments may be implemented. As shown in FIG. 1, system 100 includes a plurality of networks 102, 104, and 106. In particular, core network 102, wireless network 104, and wireline network 106 are depicted. It should be noted that while only these three types of networks are depicted in FIG. 1, the present invention is not limited to only these types of networks or does not require the inclusion of all of these types of networks. Other types of communication networks may be used in addition to or in replacement of one or more of depicted networks 102, 104, and 106 without departing from the spirit and scope of the present invention.

Wireline network 106 may comprise one or more networks of the same or different types. For example, wireline network 106 may comprise one or more local area networks (LANs), wide area networks (WANs), the Internet, and the like. Similarly, wireless network 104 may comprise one or more networks of the same or different types. Essentially, any number and type or combination of types of communication networks may be used with the illustrative embodiments without departing from the spirit and scope of the present invention.

Each network 102, 104, and 106 has one or more communication devices coupled to it through either wired or wireless communication links. For example, wireline network 106 has server 108 and client devices 110-114 coupled to it via communication links generally known in the art. Client devices 110-114 preferably have the capability to perform one or more of voice telephone communications, electronic mail message communications, instant text message communications, or the like.

Wireless network 104 has a plurality of wireless communication devices 118, 120, and 122, which may be a cell phone, PDA, or the like, which communicate via wireless network 104 through wireless communication point 116, e.g., a wireless base station, wireless access point, or the like. Wireless communication devices 118, 120, and 122 may be, for example, wireless telephones, personal digital assistants, pagers, or the like. Wireless communication devices 118, 120, and 122 preferably have the capability to perform one or more of voice telephone communications, electronic mail message communications, instant text message communications, or the like. Wireless network 104 is a network in which messages, communications, information, or the like may be communicated between devices and such messages, communications, information, or the like may be essentially any type of data.

Core network 102 is the central part of a telecommunication network that provides various services to customers who are connected by the access networks, such as wireless network 104 and wireline network 106. One of the main functions is to route telephone calls across the public switched telephone network (PSTN). Typically, core network 102 provides paths for the exchange of information between different sub-networks. For enterprise networks serving one organization, the term backbone is more used, while for service providers, the term core network is more often used.

FIG. 2 is a block diagram of an example data processing system in which aspects of the illustrative embodiments may be implemented. Data processing system 200 is an example of a computer, such as client 110 or wireless communication devices 118 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

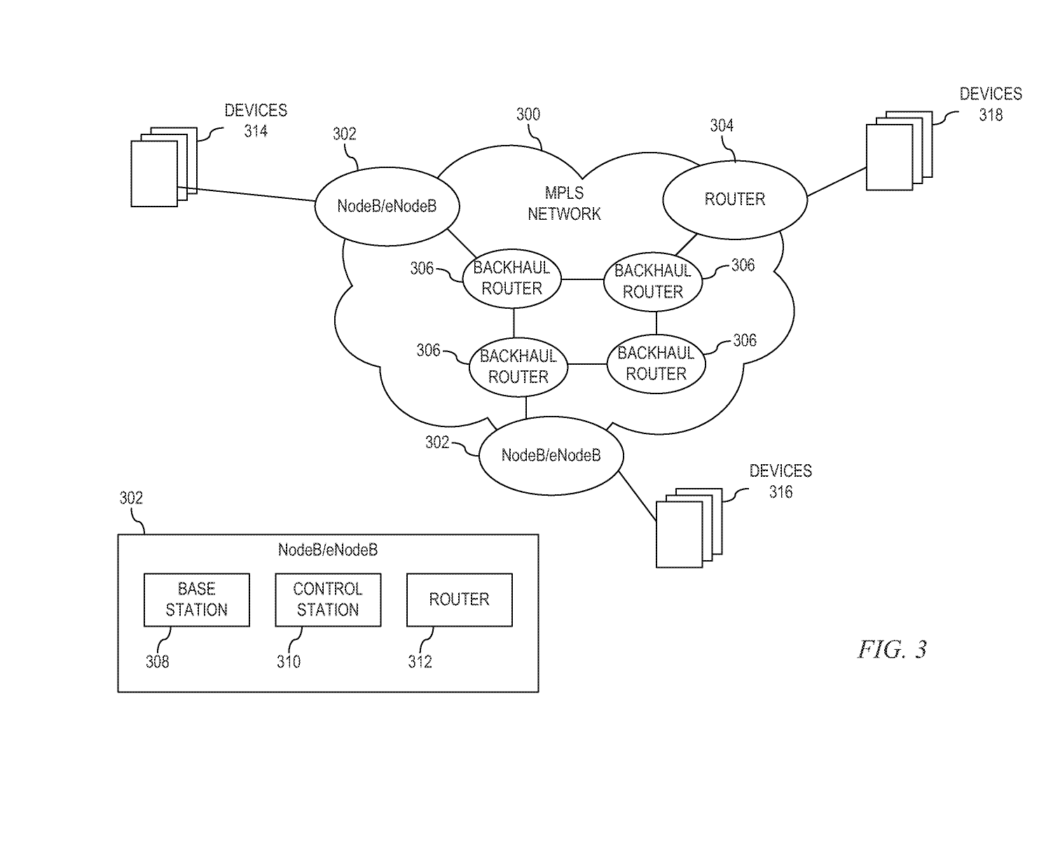

FIG. 3 depicts a block diagram schematically showing the components for providing virtual private local area network (LAN) service (VPLS) across wireline and wireless networks in accordance with an illustrative embodiment. Network 300 represents a combination of a core network, a wireless network, and a wireline network, such as core network 102, wireless network 104, and wireline network 106 of FIG. 1. At the edge of network 300 reside a plurality of wireless base stations 302 or just base stations 302 which couple mobile devices 314 to other mobile devices 316 coupled to other base stations 302 or devices 318 coupled to router 304 via a wireline network. Within network 300 reside backhaul routers 306 which receive and forward packets to other backhaul routers 306, routers 304, and base stations 302.

Base stations 302 may use a Base-station Transmission System (BTS) as a synchronous scheme and a NodeB or eNodeB as a non-synchronous scheme. Base stations 302 may utilize an interface, such as a conventionally standardized interface, an improved Internet protocol-based interface, or the interface of the illustrative embodiments, which is described in detail below. Each of base stations 302 comprises base station module 308, control station module 310, and router 312. Base station module 308 receives telephone request signals from mobile device 314 and performs location information registration for connecting with mobile device 314 in a cell area that the base station 302 covers.

Control station module 310 controls radio channel allocation and disconnection for the terminal, a transmission output control function of the base station 302, inter-cell soft hand-off and hard hand-off determination, transcoding, Vocoding, GPS (Global Positioning System) clock distribution, and management and maintenance functions of the base station 302. Control station module 310 may be a Base Station Controller (BSC) in a synchronous scheme and may be a Radio Network Controller (RNC) in a non-synchronous scheme. Control station module 310 may utilize a previously standardized packet interface in order to be connected to network 300 though an IP backbone and may use newly configured equipment.

As shown in FIG. 3, the conventional Internet protocol-based mobile communication system configures a transmission network using conventional wire Internet equipment, that is, equipment such as the router 312 or a switch (not shown), and has a separated structure that is divided into a transmission layer and an application layer by providing a mobile communication function to an application layer. Such a structure has a problem with packet data delay and non-efficiency in an access network requiring wireless access control and mobility control functions. Router 312 is for connecting inter-layers of a network with each other through a device for connecting the separated networks using the same transmission protocol, and performs packet switching, packet forwarding, packet filtering, routing, and the like.

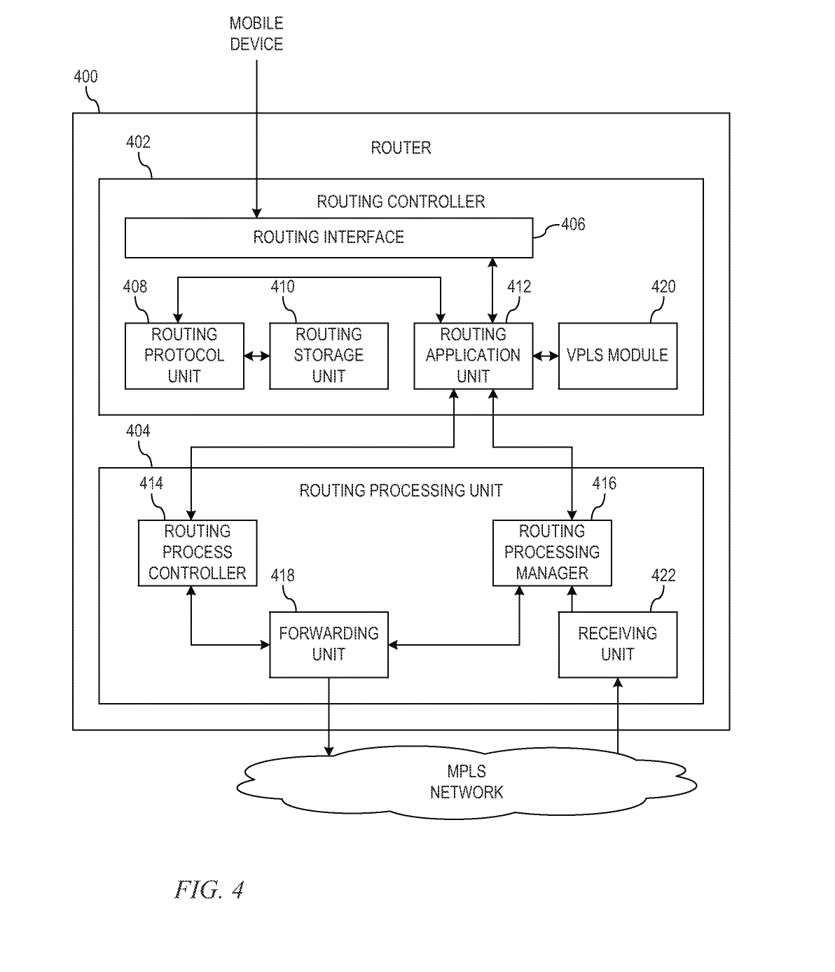

FIG. 4 depicts a block diagram of a router, such as routers 304, 306, and 312 within base stations 302 of FIG. 3, illustrating an inner structure of the router in accordance with an illustrative embodiment. Router 400 comprises routing controller 402 and routing processing unit 404. Routing controller 402 further comprises routing interface 406, routing protocol unit 408, routing storage unit 410, routing application unit 412, and virtual private local area network (LAN) service (VPLS) module 420. Routing interface 406 processes the traffic and control signals received from a mobile device. Routing protocol unit 408 processes the routing protocol and performs routing table generation and maintenance and system operation maintenance functions. Routing protocol unit 408 finds a destination address of the Internet protocol header, compares the found destination address with each entry of the generated routing table, and performs a routing entry synchronization function. Routing protocol unit 408 includes a Routing Information Protocol (RIP) module, an Open Shortest Path First (OSPF) module, an Intermediate System (ISIS) module, and a Border Gateway Protocol (BGP) module. Routing protocol unit 408 may include a module for performing other protocols as well as the above-noted protocols.

Routing storage unit 410 receives and stores routing table information as a path from routing protocol unit 408 to the specified destination on the network, and information for finding optimum packet paths. Routing application unit 412 converts a wireless signal received from the mobile device into one or more internet protocol (IP) packets. Routing application unit 412 then determines the Forwarding Equivalence Class (FEC) of the packets in order to identify which of the IP packets are similar and/or have identical characteristics so that those IP packets may be forwarded the same way. Once those IP packets are identified, routing application unit 412, working in conjunction with VPLS module 420, constructs a VPLS virtual private network (VPN) multiprotocol label switching (MPLS) label in a header of each IP packet. Routing application unit 412 then identifies an egress router for the IP packets based upon their intended destination by identifying the router from the routing table information determined by routing protocol unit 408. Once the egress router is identified, routing application unit 412 uses an associated MPLS label of the egress router for MPLS routing, which is inserted into the header of the each IP packet. That is, in order that the VPLS labeled IP packet may be transmitted to an egress router, whether the egress router is wireless or wireline associated, the IP packet must be transmitted through a MPLS network. Thus, routing application unit 412 adds an additional label for MPLS routing to the header of each IP packet. Once the VPLS and MPLS labels have been added, routing application unit 412 sends a notification of the ready IP packets to routing processing unit 404.

Routing processing unit 404 comprises routing processing controller 414, routing processing manager 416, and forwarding unit 418. Routing processing controller 414 controls the system to perform switching, forwarding, filtering, and routing functions of the received Internet protocol packet according to the control signal of the routing application unit 412. Routing processing manager 416 manages general routing functions such as the inner signal processing, forwarding table generation, and packet recombination of the routing processor according to the control signals of the routing application unit 412. Forwarding unit 418 analyzes header information in each IP packet when the IP packets are input, and opens a packet transmission path to the corresponding output port with reference to a forwarding table from which the IP packets are transmitted to a next router in the path to the egress router. Forwarding unit 418 performs a series of functions for transmitting packets to the final destination network using the header information of the received Internet protocol packet. The packet header information has included only 2 or 3-layer packet header information. Recently, they have come to include 4-layer header information. Accordingly, forwarding unit 418 performs packet classification for referring to the 4-layer header information. In addition, the packet header information may include 5 or more layers of header information in next generation switching equipment to provide various services such as audio or video streaming communication QoS guarantee, firewall, or web switching.

For the egress router or backhaul routers, when receiving VPLS and MPLS labeled IP packets, routing processing unit 404 also comprises receiving unit 422. Receiving unit 422 forwards IP packet to routing application unit 412. Routing application unit 412 examines the top label which is the MPLS label. Routing application unit 412 performs a lookup in a label forwarding information data structure to identify the egress router that the IP packets are to be forwarded to. Upon identifying the egress router, routing application unit 412 determines whether the current backhaul router is the last backhaul router before the egress router. If the current backhaul router is not the last backhaul router before the egress router, routing application unit 412 removes the current MPLS label and adds a new MPLS label indicating the routing for the next backhaul router. If the current backhaul router is the last backhaul router before the egress router, routing application unit 412 removes the current MPLS label and sends the IP packet onto the egress router via routing processing unit 404 and the previously described process.

When the egress router receives the IP packet, receiving unit 422 forwards the IP packet to routing application unit 412. Routing application unit 412 identifies that this is the last node before the IP packet is to be forwarded to the destination device. Therefore, routing application unit 412 removes the VPLS VPN MPLS label and then sends the IP packet onto the destination device via routing interface 406.

Thus, the illustrative embodiments provide a MPLS function in wireless base stations (NodeB/eNodeB) to enable VPLS service, thereby extending the VPLS service to the wireless base station level. As a result, a wireless network is treated as network path corresponding to optical network in wireline network. Relating to the current extended role of VPLS in the presence of wireless networks, VPLS works to realize the network-based micro mobility in such cellular networks.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

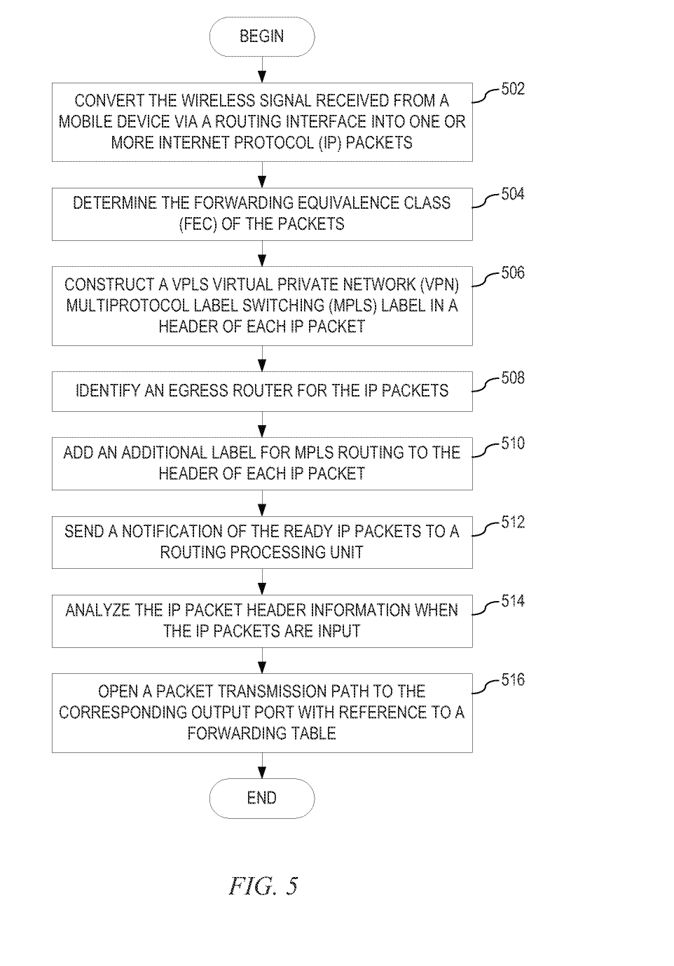

FIG. 5 depicts a flowchart outlining exemplary operations performed within an ingress base station (NodeB/eNodeB) to enable VPLS service in accordance with an illustrative embodiment. As the operation begins, a routing application unit converts the wireless signal received from a mobile device via a routing interface into one or more internet protocol (IP) packets (step 502). The routing application unit then determines the Forwarding Equivalence Class (FEC) of the packets (step 504) in order to identify which of the IP packets are similar and/or have identical characteristics so that those IP packets may be forwarded the same way. Once those IP packets are identified, the routing application unit, working in conjunction with a VPLS module, constructs a VPLS virtual private network (VPN) multiprotocol label switching (MPLS) label in a header of each IP packet (step 506). The routing application unit then identifies an egress router for the IP packets (step 508) based upon their intended destination by identifying the router from the routing table information determined by a routing protocol unit. Once the egress router is identified, the routing application unit uses an associated MPLS label of the egress router for MPLS routing, which is inserted into the header of the each IP packet (step 510). That is, in order that the VPLS labeled IP packet may be transmitted to an egress router, whether the egress router is wireless or wireline associated, the IP packet must be transmitted through and MPLS network. Thus, the routing application unit adds an additional label for MPLS routing to the header of each IP packet. Once the VPLS and MPLS labels have been added, the routing application unit sends a notification of the ready IP packets to a routing processing unit (step 512).

A forwarding unit within the routing processing unit analyzes the IP packet header information when the IP packets are input (step 514), and opens a packet transmission path to the corresponding output port with reference to a forwarding table (step 516) from which the IP packets are transmitted to a next router in the path to the egress router, with the operation terminating thereafter. The forwarding unit performs a series of functions for transmitting packets to the final destination network using the header information of the received Internet protocol packet. The packet header information has included only 2 or 3-layer packet header information. Recently, they have come to include 4-layer header information. Accordingly, the forwarding unit performs packet classification for referring to the 4-layer header information. In addition, the packet header information may include 5 or more layers of header information in next generation switching equipment to provide various services such as audio or video streaming communication QoS guarantee, firewall, or web switching.

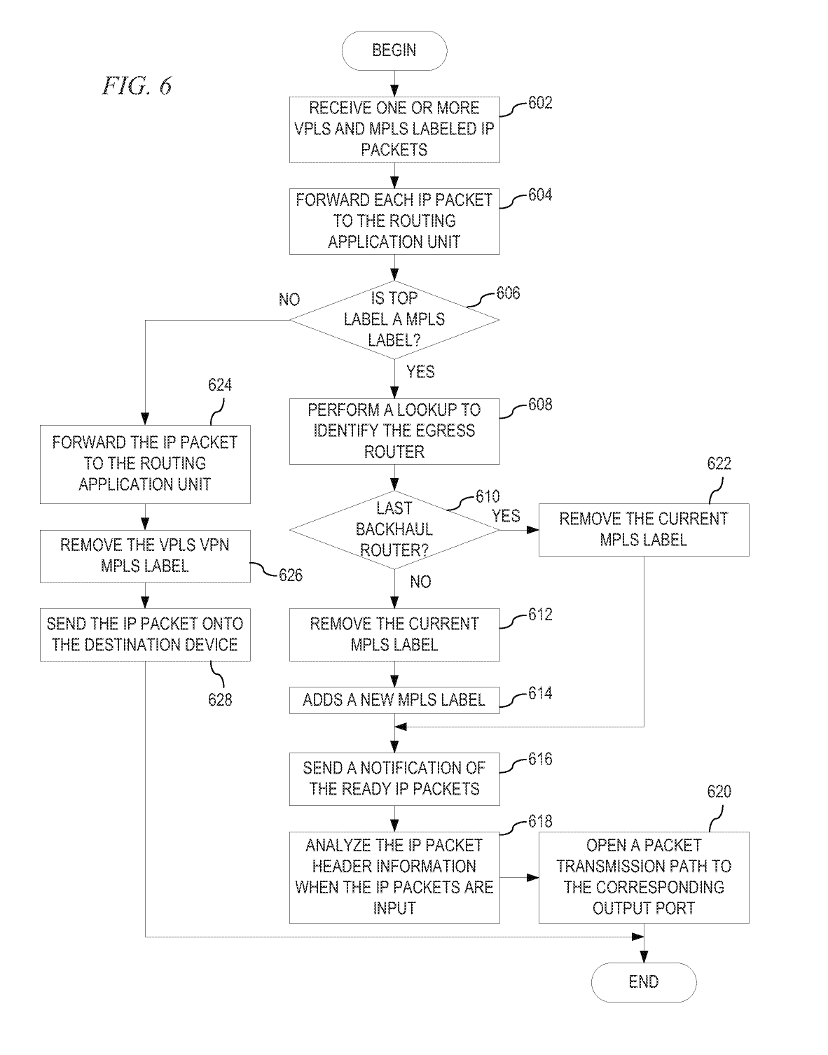

FIG. 6 depicts a flowchart outlining exemplary operations performed within backhaul routers and routers within egress base stations (NodeB/eNodeB) to enable VPLS service in accordance with an illustrative embodiment. As the operation begins, a receiving unit within the routing processing unit within a router, backhaul or egress, receives one or more VPLS and MPLS labeled IP packets (step 602). The receiving unit forwards each IP packet to the routing application unit (step 604). The routing application unit examines the top label to determine whether the label is a MPLS label (step 606). If at step 606 the top label is a MPLS label indicating that the current router is a backhaul router, the routing application unit performs a lookup in a label forwarding information data structure to identify the egress router that the IP packets are to be forwarded to (step 608). Upon identifying the egress router, the routing application unit determines whether the current backhaul router is the last backhaul router before the egress router (step 610).

If at step 610 the current backhaul router is not the last backhaul router before the egress router, the routing application unit removes the current MPLS label (step 612) and adds a new MPLS label indicating the routing for the next backhaul router (step 614). Once the new MPLS label has been added, the routing application unit sends a notification of the ready IP packets to the routing processing unit (step 616). The forwarding unit analyzes the IP packet header information when the IP packets are input (step 618) and opens a packet transmission path to the corresponding output port with reference to a forwarding table (step 620) from which the IP packets are transmitted to a next router in the path to the egress router, with the operation terminating thereafter. If at step 610 the current backhaul router is the last backhaul router before the egress router, the routing application unit removes the current MPLS label (step 622), with the process continuing to step 616 thereafter.

If at step 606 the top label is not a MPLS label indicating that the current router is the egress router, the receiving unit forwards the IP packet to the routing application unit (step 624). The routing application unit then removes the VPLS VPN MPLS label (step 626) and sends the IP packet onto the destination device via the routing interface (step 628), with the operation terminating thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for integrating both wireline and wireless networks by extending the service of VPLS to wireless customers. Ultimately, the VPN service provides coverage up to the wireless base stations (NodeB/eNodeB), incorporating the router functions at these nodes. As a result, a wireless network is treated as network path corresponding to optical network in wireline network. Relating to the current extended role of VPLS in the presence of wireless networks, VPLS works to realize the network-based micro mobility in such cellular networks. Micro mobility is defined as mobility that is anchored at a fixed IP gateway device; hence, the mobile device is in the micro mobility domain as long as the mobile device's IP gateway does not change as the mobile device moves location. The illustrative embodiments utilize the anchor device (router functions) residing in the wireless base stations (NodeB/eNodeB) or the wireless network to serve a service-oriented IP-enabled router that stores policies and other information, working as a network transmission path.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for enabling virtual private local area network (LAN) service (VPLS) service within a base station (NodeB/eNodeB), the method comprising:
receiving, by a first processor within a router of the base station, a wireless signal from a mobile device;
converting, by the first processor, the wireless signal into one or more internet protocol (IP) packets;
constructing, by the first processor, a VPLS virtual private network (VPN) multiprotocol label switching (MPLS) label in a header of each IP packet;
identifying, by the first processor, an egress router for the IP packets;
constructing, by the first processor, a MPLS label of the egress router for MPLS routing;
adding, by the first processor, the MPLS label on top of the VPLS VPN MPLS label in the header of each IP packet; and
forwarding, by the first processor, the one or more IP packets to at least one other router within a MPLS network.

2. The method of claim 1, wherein the VPLS VPN MPLS label is constructed using a VPLS module in the router of the base station.

3. The method of claim 1, further comprising:
determining, by the first processor, a Forwarding Equivalence Class (FEC) of each of the one or more IP packets, wherein determining the FEC of each of the one or more IP packets identifies which of the IP packets are similar or have identical characteristics in order that similar IP packets or IP packets with identical characteristics are forwarded in a same manner.

4. The method of claim 1, wherein forwarding the one or more IP packets to the at least one other router within the MPLS network comprises:
analyzing, by the first processor, IP packet header information within each IP packet; and
opening, by the first processor, a packet transmission path to a corresponding output port with reference to a forwarding table from which the one or more IP packets are transmitted to the at least one other router in a path to the egress router.

5. The method of claim 1, further comprising:
receiving, by a second processor within the at least one other router, the one or more IP packets;
for each IP packet, determining, by the second processor, whether a top label of the IP packet is a MPLS label;
responsive to the top label being the MPLS label, performing, by the second processor, a lookup in a label forwarding information data structure to identify the egress router that the IP packet is to be forwarded to;
responsive to identifying the egress router, determining, by the second processor, whether the at least one other router is a last router before the egress router;
responsive to the at least one other router failing to be the last router before the egress router, removing, by the second processor, the MPLS label;
adding, by the second processor, a new MPLS label indicating the routing for a next backhaul router; and
forwarding, by the second processor, the IP packet to the next backhaul router within the MPLS network.

6. The method of claim 5, further comprising:
responsive to the at least one other router being the last router before the egress router, removing, by the second processor, the MPLS label; and
forwarding, by the second processor, the IP packet to the egress router within the MPLS network.

7. The method of claim 5, further comprising:
responsive to the top label failing to be the MPLS label, removing, by the second processor, the VPLS VPN MPLS label; and
sending, by the second processor, the IP packet onto a destination device.

8. A computer program product comprising a computer readable storage medium having a computer readable program stored therein, wherein the computer readable program, when executed on a (NodeB/eNodeB) computing device, causes the (NodeB/eNodeB) computing device to:
receive a wireless signal from a mobile device;
convert the wireless signal into one or more internet protocol (IP) packets;
construct a VPLS virtual private network (VPN) multiprotocol label switching (MPLS) label in a header of each IP packet;
identify an egress router for the IP packets;
construct a MPLS label of the egress router for MPLS routing;
add the MPLS label on top of the VPLS VPN MPLS label in the header of each IP packet; and
forward the one or more IP packets to at least one other router within a MPLS network.

9. The computer program product of claim 8, wherein the VPLS VPN MPLS label is constructed using a VPLS module in the router of the base station.

10. The computer program product of claim 8, wherein the computer readable program further causes the (NodeB/eNodeB) computing device to:
determine a Forwarding Equivalence Class (FEC) of each of the one or more IP packets, wherein determining the FEC of each of the one or more IP packets identifies which of the IP packets are similar or have identical characteristics in order that similar IP packets or IP packets with identical characteristics are forwarded in a same manner.

11. The computer program product of claim 8, wherein the computer readable program to forward the one or more IP packets to the at least one other router within the MPLS network further causes the (NodeB/eNodeB) computing device to:
analyze IP packet header information within each IP packet; and
open a packet transmission path to a corresponding output port with reference to a forwarding table from which the one or more IP packets are transmitted to the at least one other router in a path to the egress router.

12. The computer program product of claim 8, wherein the computer readable program further causes a different computing device to:
receive the one or more IP packets;
for each IP packet, determine whether a top label of the IP packet is a MPLS label;
responsive to the top label being the MPLS label, perform a lookup in a label forwarding information data structure to identify the egress router that the IP packet is to be forwarded to;
responsive to identifying the egress router, determine whether the at least one other router is a last router before the egress router;
responsive to the at least one other router failing to be the last router before the egress router, remove the MPLS label;
add a new MPLS label indicating the routing for a next backhaul router; and
forward the IP packet to the next backhaul router within the MPLS network.

13. The computer program product of claim 12, wherein the computer readable program further causes the different computing device to:
responsive to the at least one other router being the last router before the egress router, remove the MPLS label; and
forward the IP packet to the egress router within the MPLS network.

14. The computer program product of claim 12, wherein the computer readable program further causes the different computing device to:
responsive to the top label failing to be the MPLS label, remove the VPLS VPN MPLS label; and
send the IP packet onto a destination device.

15. An apparatus, comprising:
a first processor within a router; and
a memory coupled to the first processor, wherein the memory comprises instructions which, when executed by the first processor, cause the first processor to:
receive a wireless signal from a mobile device;
convert the wireless signal into one or more internet protocol (IP) packets;
construct a VPLS virtual private network (VPN) multiprotocol label switching (MPLS) label in a header of each IP packet;
identify an egress router for the IP packets;
construct a MPLS label of the egress router for MPLS routing;
add the MPLS label on top of the VPLS VPN MPLS label in the header of each IP packet; and
forward the one or more IP packets to at least one other router within a MPLS network.

16. The apparatus of claim 15, wherein the VPLS VPN MPLS label is constructed using a VPLS module in the router of the base station.

17. The apparatus of claim 15, wherein the instruction further causes the first processor to:
determine a Forwarding Equivalence Class (FEC) of each of the one or more IP packets, wherein determining the FEC of each of the one or more IP packets identifies which of the IP packets are similar or have identical characteristics in order that similar IP packets or IP packets with identical characteristics are forwarded in a same manner.

18. The apparatus of claim 15, wherein the instructions to forward the one or more IP packets to the at least one other router within the MPLS network further causes the first processor to:
analyze IP packet header information within each IP packet; and
open a packet transmission path to a corresponding output port with reference to a forwarding table from which the one or more IP packets are transmitted to the at least one other router in a path to the egress router.

19. The apparatus of claim 15, further comprising:
a second processor within a router; and
the memory coupled to the second processor, wherein the memory comprises instructions which, when executed by the second processor, cause the second processor to:
receive the one or more IP packets;
for each IP packet, determine whether a top label of the IP packet is a MPLS label;
responsive to the top label being the MPLS label, perform a lookup in a label forwarding information data structure to identify the egress router that the IP packet is to be forwarded to;
responsive to identifying the egress router, determine whether the at least one other router is a last router before the egress router;
responsive to the at least one other router failing to be the last router before the egress router, remove the MPLS label;
add a new MPLS label indicating the routing for a next backhaul router; and
forward the IP packet to the next backhaul router within the MPLS network.

20. The apparatus of claim 19, wherein the instruction further causes the second processor to:
responsive to the at least one other router being the last router before the egress router, remove the MPLS label; and
forward the IP packet to the egress router within the MPLS network.

21. The apparatus of claim 19, wherein the instruction further causes the second processor to:
responsive to the top label failing to be the MPLS label, remove the VPLS VPN MPLS label; and
send the IP packet onto a destination device.
